(19) United States
(12) Patent Application Publication
(10) Pub. No.: US 2026/0001521 A1
(43) Pub. Date: Jan. 1, 2026

(54) ELECTROMECHANICAL BRAKE DEVICE WITH A COMPACT LINEAR ACTUATOR

(71) Applicant: Continental Automotive Technologies GmbH, Hannover (DE)

(72) Inventors: I-Che Chiang, Frankfurt am Main (DE); Marco Besier, Bad Schwalbach (DE); Dirk Pauly, Frankfurt (DE); Mathias Haag, Darmstadt (DE); Sven Rückert, Reinheim (DE); Andreas Schirling, Darmstadt (DE); Markus Neumann, Mannheim (DE); Dirk Theobald, Eschborn (DE)

(73) Assignee: Continental Automotive Technologies GmbH, Hannover (DE)

(21) Appl. No.: 19/246,994

(22) Filed: Jun. 24, 2025

(30) Foreign Application Priority Data
Jul. 1, 2024 (DE) 10 2024 206 142.5
Sep. 9, 2024 (DE) 10 2024 208 556.1

(51) Int. Cl. B60T 13/74; B60T 17/22; F16D 55/226; F16D 65/18; F16D 66/00; F16D 121/24; F16D 125/40; F16D 125/50

(52) U.S. Cl. CPC B60T 13/746; B60T 17/22; F16D 55/226; F16D 65/18; F16D 66/00; F16D 2066/005; F16D 2121/24; F16D 2125/40; F16D 2125/50

(57) ABSTRACT

An electromechanical brake device with a linear actuator for moving a brake piston in an electromechanically operable wheel brake of a motor vehicle, and to a motor vehicle having an electromechanical brake device of this type. The electromechanical brake device has an actuator unit wherein the actuator unit comprises a rotational-translational movement converter having a piston movable in an axial direction and a spindle wherein the spindle is hollow at least in portions, to at least partially define a cavity, a force transmission unit, which comprises a planetary gearbox with a sun gear, planet gears, a planet carrier and a ring gear, and an axial bearing located in the cavity for absorbing axial forces occurring during brake application. The electromechanical brake device herein can also comprise a force sensor.

### TECHNICAL FIELD

The present embodiments generally relate to an electromechanical brake device with a linear actuator for moving a brake piston in an electromechanically operable wheel brake of a motor vehicle, and to a motor vehicle having an electromechanical brake device of this type. The electromechanical brake device herein can also comprise a force sensor.

### BACKGROUND

Electromechanical wheel brakes (“EMB”) are now used in modern motor vehicles, and are increasingly also used as service brakes in comparison to conventional, hydraulically activated wheel brakes. With electromechanical wheel brakes, there is no longer any need for a complex hydraulic system, and an electromechanical wheel brake also occupies significantly less space.

Electromechanical wheel brakes of this type typically have an electronic drive unit which interacts with a mechanism or a gear unit. A brake unit can then be arranged on the output side, and this can comprise, for example, a brake piston and a friction pad which can be pressed onto a rotating friction partner by means of translational movement. It is thereby possible to bring about deceleration during operation.

To this end, the drive unit typically comprises at least one electric motor which has a high output density. The mechanical connection to the friction brake can then be established by means of at least the gear mechanism. In addition to factors such as efficiency and rigidity, above all the mechanical design, the installation space requirement and the transmission characteristic determine the potential applications of the wheel brake.

Corresponding mechanisms are known for converting the rotational movement of the electric motor to the required translational or linear movement, for example a ball screw as rotational-translational movement converter.

These do not offer the possibility of a non-linear force transmission such as, for instance, ball ramp mechanisms. On the other hand, however, complex wear compensation does not need to be provided, as the effective stroke may be longer than with rotational-translational movement converters with a ramp mechanism.

Known electromechanical brake devices with a ball screw as rotational-translational movement converter are therefore of a relatively long construction in order to cover comparatively longer displacements, also with regard to wear compensation, this however being potentially difficult with regard to the installation situation and the space requirement.

Further, sensors, such as force sensors, for instance, are often still required in order to be able to determine the forces that occur when the brake is activated. These items of information can be used to actuate the brake. Typically, these force sensors are installed in series, for example as a ring force sensor, for example behind the rotational-translational movement converter or an associated gear unit. This can lead to a further increase in the installation length of the electromechanical wheel brake. However, electromechanical wheel brakes in an even longer construction mode can lead to installation complications in motor vehicles, especially on the front axle of passenger motor cars since, due to the steering angle, an short axial installation length, i.e. extent in a direction of the piston axis, is helpful.

Therefore, an electromechanically activatable brake device, which at least mitigates the aforementioned difficulties is helpful.

### SUMMARY

This object is achieved by an electromechanical brake device, in particular for a motor vehicle, and by a motor vehicle, as described herein.

In a first aspect, an electromechanical brake device, for example for a motor vehicle, comprises an actuator unit, wherein the actuator unit comprises a rotational-translational movement converter having a piston, disposed so as to be movable in the axial direction, and a spindle, and a force transmission unit, wherein the force transmission unit comprises a planetary gearbox with a sun gear, planet gears, a planet carrier and a ring gear, wherein the spindle is designed to be hollow at least in portions, as a result of which a cavity is determined, and wherein provided in the cavity is an axial bearing, for example for absorbing axial forces occurring during brake application.

The electromechanical brake device can furthermore comprise a caliper housing. The piston can be conceived to be movable in the axial direction relative to the caliper housing.

An electromechanically activatable wheel brake, for example an electromechanically activatable disk brake, with a short installation size in the axial direction is made available by the electromechanical brake device described in more detail below. Certain embodiments allow the integration of a sensor.

The electromechanical brake device can furthermore comprise a drive unit. Due to the mutual arrangement of the planetary gearbox and the spindle, a very short installation length of the electromechanical brake device in a direction parallel to the symmetry axis of the piston is possible.

The axial bearing in the cavity of the spindle can absorb axial forces that occur when the brake is being applied. For this purpose, the planet carrier can protrude at least in portions into the cavity. The axial bearing can be disposed between a piston-proximal stop of the spindle and the end face of the planet carrier in the cavity of the spindle.

Moreover, the embodiments makes it possible to dispose and integrate a sensor, for example a force sensor, directly in the interior of the spindle in the cavity.

In a further aspect, the embodiments also relate to an electromechanical brake device, for example for a motor vehicle, comprising a caliper housing with an actuator receptacle, wherein the force transmission unit and/or the actuator unit are/is disposed at least in portions in the actuator receptacle.

The disposal of the force transmission unit at least in part, but maybe completely, in the actuator receptacle of the caliper housing reduces the installation length of the brake device.

In the context of the embodiments, a motor vehicle may be understood to mean a vehicle having axles, wherein at least one of these axles can comprise steerably guided wheels and, furthermore, the drive of the wheels of at least one axle can be adaptable in a wheel-specific manner.

The electromechanically activatable wheel brakes can be embodied as electromechanical disk brakes (e-calipers), specifically for both front and rear axle applications in motor vehicles.

The configuration of an electromechanical brake device described below is shown purely as an example using an electromechanical disk brake for setting defined brake application forces. A transfer to an electromechanical drum brake for setting defined spreading forces or braking torques is possible for a person skilled in the art without any problems.

The electromechanical disk brakes can be embodied in such a manner that a brake application force can be generated by means of the electric motor, a splitter box and a rotational-translational movement converter. The brake application force in this case refers to the force with which the brake pads are pressed against the brake disk, then produces a corresponding braking torque at the wheel in question. Depending on the embodiment and closed-loop control concept, the actuation of the electromechanical disk brakes can be designed in such a way that either a specified, defined clamping force or a specified, defined braking torque can be set in accordance with the deceleration demand requested.

The electromechanically operable drum brakes (e-drum) may be embodied so that a motor/gear mechanism unit actuates an expansion module which presses the brake pads against the brake drum with a spreading force determined on the basis of the desired deceleration requested and thus produces a corresponding braking torque.

The caliper housing of the electromechanical brake device can be embodied based on common designs for disk brake housings, for example for a floating caliper brake or for a first caliper brake. The caliper housing may also be embodied here as a multi-piston unit or multi-piston caliper and comprise more than one actuator unit, for example two actuator units, wherein suitable actuator receptacles can be provided on the caliper housing accordingly. In this way, the caliper housing can be designed, for example, as a two-piston first caliper. The caliper housing can comprise corresponding mounts for fastening friction pads for implementing a disk brake.

The actuator receptacle of the caliper housing can be designed for receiving and/or mounting the actuator unit and/or the force transmission unit. For this purpose, the actuator receptacle can comprise a substantially cylindrical portion in which the actuator unit and/or the force transmission unit can be disposed at least in portions. According to a embodiment, the caliper housing and the actuator receptacle can be designed integrally and/or monolithically. Suitable materials can comprise, for example, a casting material.

The drive unit can comprise an electric motor, for example an electric motor for operating the electromechanical brake device as a constituent part of a motor vehicle brake of a motor vehicle. Therefore, the drive unit can be designed to generate a drive torque which can be transmitted to the actuator unit via the force transmission unit. Suitable gear mechanisms may be provided for force transmission, for example spur gear units or planetary gearboxes. The gear unit can likewise be integrated into the drive unit.

The actuator unit can comprise a rotational-translational movement converter which, based on the drive torque, is designed to displace the piston in an axial movement relative to the caliper housing. A spindle to which the drive torque can be transmitted, and a threaded nut can be provided for the conversion into an axial movement, wherein the threaded nut can convert a rotational movement of the spindle into an axial movement. In this way, friction pads can be moved toward and pressed against a rotating element, e.g. a brake disk, to generate a predetermined braking torque when applying the brake.

According to one embodiment, the piston and the threaded nut can also be fixedly, for example co-rotationally, connected to one another.

With reference to the brake device, the application direction, that is to say an axial direction, in which the piston is moved to generate a brake force, is hereinafter referred to as the piston side or piston-proximal, whereas the opposite direction, and consequently the release direction, in which the drive unit can be located in an extension of the spindle, is also referred to as the drive-side of the brake device or drive-proximal.

The electromechanical brake device can furthermore be distinguished by one or a plurality of the following features.

The rotational-translational movement converter of the electromechanical brake device can be designed as a ball screw comprising the threaded nut and balls for force transmission. In contrast to a ball-rail mechanism as a rotational-translational movement converter, for instance, no readjustment is required for ball screws, and the potential piston stroke movements can also be greater.

According to a first embodiment the spindle can be embodied to be hollow at least in a drive-proximal portion. According to this embodiment, the spindle may comprise a cylindrical, continuous cavity or a through-bore. However, it may also suffice to only equip a drive-proximal portion of the spindle with a cavity.

This makes it possible to dispose in the interior of the spindle not only an axial bearing for absorbing axial forces, but also a deformation member which can comprise a force sensor, and thus to detect quasi in the center of the actuator unit the forces present during brake application. The measured values obtained in the process can be relayed from the actuator unit as digital signals via corresponding signal lines, which can be integrated in a transmission element, from this deformation member through the cavity of the spindle in the direction of the drive side, for example to a control unit (“ECU”) disposed outside the actuator unit.

According to a embodiment, a washer bearing, which can be disposed in a piston-proximal portion of the spindle and fixed or supported in the axial direction by a stop in the spindle, for force absorption or force transmission can furthermore be provided in the cavity. In this way, an axial force acting on the spindle during brake application can be transmitted to the washer bearing which may be designed to be sufficiently stiff for transmitting axial forces.

Furthermore, an axial washer bearing, which proximal to the piston is in contact with the washer bearing via the axial bearing and can thus absorb axial forces from the washer bearing, can be provided in the cavity of the spindle. For example, the axial bearing can be embodied as a single-row or double-row cylindrical roller bearing.

The axial bearing can therefore be disposed in the force flux between the washer bearing and the axial washer bearing.

According to an embodiment, the opposite, drive-proximal end face of the axial washer bearing can be embodied to be spherically convex at least in the region close to the center. As a result, an occurring axial force can be concentrated in a point close to the central axis, or a centric point, which axial force can then act on the deformation member disposed so as to be contiguous proximal to the drive.

Accordingly, the deformation member, which proximal to the piston is in contact with the axial washer bearing, can be provided in the cavity of the spindle. The deformation member may be in contact with the centric, spherically designed region of the end face of the axial washer bearing, so that axial forces acting on the axial washer bearing can be optimally transferred to the deformation member.

In order to be able to absorb the axial force accordingly, the deformation member can be supported proximal to the drive, for example on the planet carrier, which is yet to be discussed in more detail hereunder.

According to an embodiment, the deformation member can be designed as a force sensor, or comprise a force sensor. Accordingly, the deformation member can comprise at a suitable location at least one sensor element which is designed to detect deformations. The action of axial pressure on the piston-proximal end face of the deformation member can, for instance, lead to mechanical stresses on the opposite, drive-proximal end face. Tensile or compressive stresses can arise here, which can be detected. Strain gauges, for example, can be used as a sensor element for detection. According to an embodiment, two or a plurality of such measuring grids can also be used, also for detecting different types of stress, i.e. tensile or compressive stresses.

Corresponding devices for processing or preparing the measured data can be provided on the force sensor, or in combination therewith. For this purpose, for example, a sensor PCB which can comprise the required electronic component parts and components can be provided.

In order to transport the resulting signals in the form of data from the deformation member within the spindle to the outside of the spindle, for example to a control unit outside the spindle, a elongate transmission element can be provided, which can lead to the outside through the cavity of the spindle.

For electrical contacting, the deformation member proximal to the drive can have electrical contact faces on which the signals can be made available and transmitted to electrical conductors of the transmission element. The at least one electrical contact face can be provided, for example, on the sensor PCB.

According to an embodiment, a sleeve can be provided between the transmission element and the deformation member, which can enclose the transmission element and the deformation member at least in portions, and which may be embodied to seal in a metallic manner. In this way, the transition region and/or the transmission element can be protected from contamination and/or lubricants. For example, the sensor PCB and/or the contact face can be disposed in this region. For example, the sleeve can be made of a metallic material and be fastened by means of a press fit.

The transmission element can be designed for signal or data transmission and, for example, have at least one continuous electrical conductor, which proximal to the piston can be connected in an electrically conducting manner to the electrical contact face, and which proximal to the drive can connected to a control unit or any other electronic device, for example a printed circuit board, which is assigned to the drive unit. Accordingly, this control unit can be disposed outside the spindle and/or outside the caliper housing, for example as part of the drive unit or else as a local brake control unit (“WCU”). The transmission element can lead through the force transmission unit.

The arrangement and structure of the electromechanical brake device can be of such a type that the symmetry axes of the piston, threaded nut, spindle, washer bearing, axial washer bearing and/or deformation member are disposed so as to be mutually co-aligned or co-linear. In this way, an occurring axial force can be guided into the deformation member.

According to a second embodiment, the spindle can be embodied so as to be hollow only in a drive-proximal portion. This embodiment can be applied when no sensor is required. However, in embodiments of the type in which the spindle does not comprise a through-bore but only a blind bore, it is likewise possible to use a sensor as described above in the cavity defined by the blind bore. In this way, the spindle can be manufactured more cost-effectively and/or can also be embodied to be more stable.

Owing to the drive-proximal opening, the attachment to the force transmission unit can be performed analogous to the embodiment with a continuous cavity. In this embodiment, the axial washer bearing can be supported directly on the piston-proximal end face of the planet carrier.

The force transmission unit may comprise a planetary gearbox with a sun gear, planet gears, a planet carrier and a ring gear. The drive-proximal opening in the spindle offers the possibility, for example, to insert a drive shaft as a sun gear and/or a planet carrier at least in portions into this cavity, which enables a compact construction mode.

An embodiment can provide that the planet carrier is inserted in portions into the cavity and in this way represents a stop for the axial bearing. Furthermore, the planet carrier can be co-rotationally connected to the caliper housing, wherein known connecting means, for example a threaded connection, can be used.

The ring gear can be co-rotationally connected to the spindle. The torque, which can be provided by an electric motor of the drive unit, can thus be transmitted via the sun gear and the planet gears to the ring gear, which also rotates as a result of the fixed planet carrier. The torque can then be transferred to the spindle via the ring gear. This enables a compact construction.

According to a further embodiment, the ring gear can have a radially projecting lobe, such as in the region of the piston-proximal end face. This lobe can be operatively connected to a projection or pin on an anti-rotation ring which can sit on the threaded nut and can be co-rotationally connected thereto, when the threaded nut is fully retracted. In this way, a type of rotary stop or end stop can be formed.

In a further aspect, the embodiments also comprises a motor vehicle comprising at least one electromechanical brake device as described above.

Further details of the invention are derived from the description of the illustrated exemplary embodiments and from the appended claims.

### BRIEF DESCRIPTION OF THE DRAWINGS

In the drawings:

FIG. 1 shows an illustration of a first exemplary electromechanical brake device, in the longitudinal section;

FIG. 2 shows a further oblique view of the exemplary electromechanical brake device, in a section from FIG. 1;

FIG. 3 shows an illustration of the actuator unit in an oblique view;

FIG. 4 shows a further illustration of the actuator unit in an oblique view, wherein the piston is not included in the illustration;

FIG. 5 shows yet a further illustration of the actuator unit in an oblique view, wherein the transmission element is not included in the illustration, with a planet carrier disk;

FIG. 6 shows yet a further illustration of the actuator unit in an oblique view from FIG. 5, wherein the transmission element and the planet carrier disk are not included in the illustration;

FIG. 7 shows an oblique view of the piston and the spindle;

FIG. 8 shows an oblique view of the ring gear;

FIG. 9 shows a top view of a caliper housing;

FIG. 10 shows an oblique view of the sun gear;

FIGS. 11a, 11b show oblique views of the force sensor with a transmission element;

FIGS. 12a, 12b show oblique views of the force sensor with and without the transmission element, respectively;

FIG. 13 shows oblique views of parts of the force sensor and of the transmission element;

FIGS. 14a, 14b show oblique views of the planet carrier;

FIGS. 15a, 15b show oblique views of the axial washer bearing;

FIG. 16 shows an illustration of a second exemplary electromechanical brake device, in the longitudinal section;

FIG. 17 shows an illustration of the actuator unit from FIG. 16, in an oblique view;

FIG. 18 shows a further illustration of the actuator unit from FIG. 16, in an oblique view, wherein the piston is not included in the illustration;

FIG. 19 shows an oblique view of the sun gear;

FIGS. 20a, 20b show oblique views of the planet carrier;

FIG. 21 shows an illustration of a third exemplary electromechanical brake device, in the longitudinal section;

FIG. 22 shows an illustration of a fourth exemplary electromechanical brake device, in the longitudinal section;

FIG. 23 shows an illustration of a locking element; and

FIG. 24 shows an illustration of a spindle with a threaded nut.

### DETAILED DESCRIPTION

In the following detailed description of embodiments, for the sake of clarity the same reference signs designate substantially identical parts in or on these embodiments. However, for better clarification, the embodiments illustrated in the figures are not always drawn to scale.

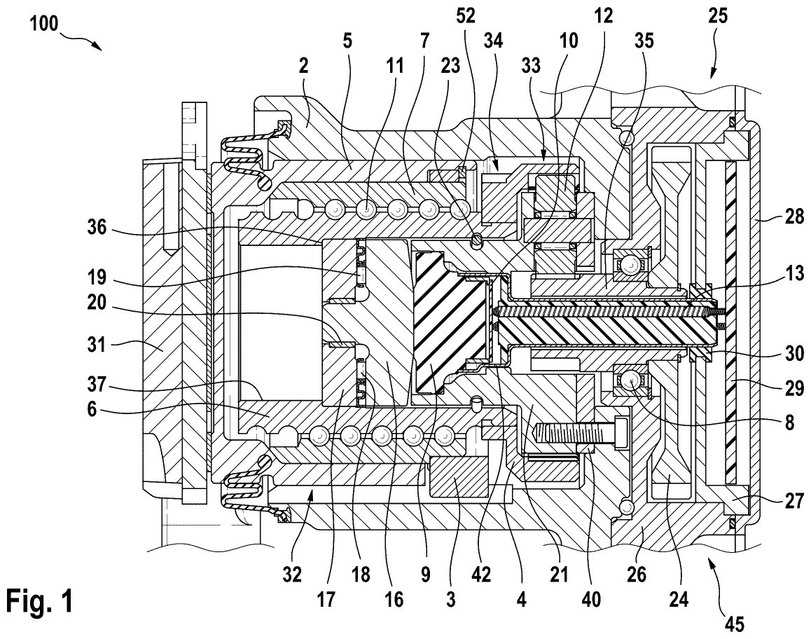

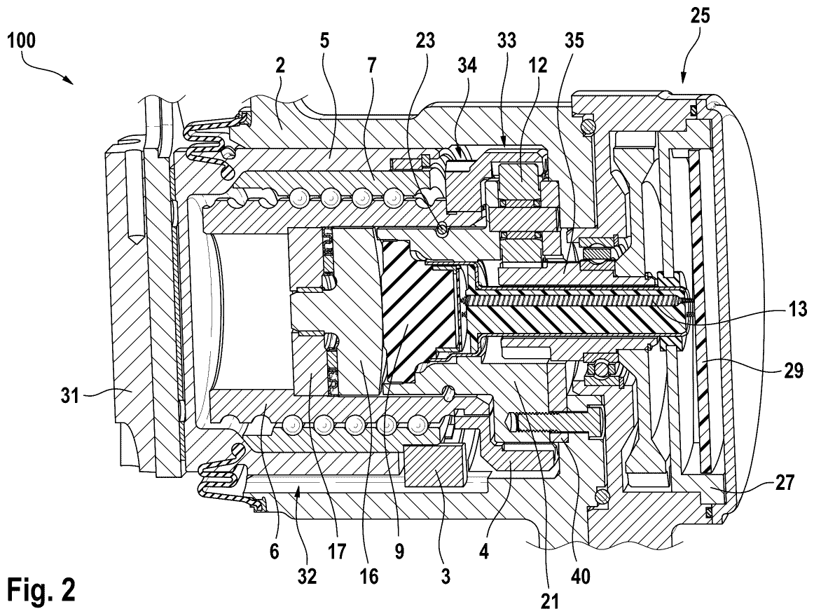

FIG. 1 shows an illustration of an exemplary first electromechanical brake device 100, in a longitudinal section. FIG. 2 shows a further oblique view of the exemplary electromechanical brake device from FIG. 1, in a section.

For reasons of clarity, only those elements of the electromechanical brake device 100 which are relevant to the design of the approach are illustrated.

The electromechanical brake device 100 is suitable for a motor vehicle and in the exemplary embodiment shown comprises:
a caliper housing 2,
an actuator unit 32, wherein the actuator unit 32 comprises a rotational translational movement converter having a piston 5, disposed so as to be movable in the axial direction relative to the caliper housing 2, and a spindle 6, and
a force transmission unit 33, wherein the force transmission unit 33 comprises
a planetary gearbox with a sun gear 35, planet gears 12, a planet carrier 21 and a ring gear 4,
wherein the spindle 6 is designed to be hollow at least in portions, as a result of which a cavity 37 is determined,
and wherein provided in the cavity 37 is an axial bearing 18, for example for absorbing axial forces occurring during brake application.

The planet carrier furthermore comprises a planet carrier disk 40 in the embodiment.

In a further aspect, the embodiments relate to an electromechanical brake device 100, for example for a motor vehicle, wherein the force transmission unit 33 and/or the actuator unit 32 are disposed at least in portions within the actuator receptacle 34.

The embodiments and configurations of the electromechanical brake device 100 described relate purely by way of example to electromechanical disk brakes for setting defined brake application forces. A transfer of the application to an electromechanical drum brake for setting defined spreading forces or braking torques is therefore possible and not excluded. The electromechanical brake device 100 can be used both for wheel brakes on the front and/or rear axles of motor vehicles.

The electromechanical brake device 100 enables a small installation size of the entire disk brake assembly in the axial direction. This is achieved by the mutual arrangement of planetary gearbox and, at least in portions, hollow spindles.

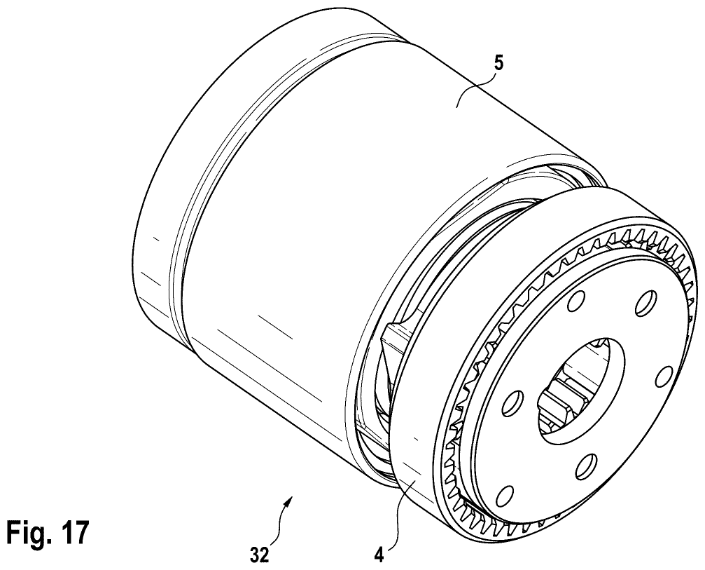

If desired, a force sensor can additionally be provided, which can be disposed in the cavity. Accordingly, the force sensor can thus be integrated directly within the spindle, the latter being hollow at least in portions for this purpose. The embodiment illustrated in FIG. 1 shows a force sensor of this type integrated into the spindle. In FIG. 17 and the following figures, further embodiments are shown, in which no such force sensor is present.

The arrangements and embodiments with regard to the electromechanical brake device 100, for example with regard to the disk brake assembly, the actuator unit 32 or the force transmission unit 33, which are illustrated below using the example of the embodiment with a force sensor, can also be transferred in an analogous manner to the further embodiments without a force sensor, illustrated further below. It should be noted at this point that, solely for reasons of clarity, not all possible combinations of embodiments and features available by the present invention are discussed below.

As can be derived from FIGS. 1 and 2, the electromechanical brake device 100, or the disk brake assembly depicted, respectively, comprise a caliper housing 2, a piston 5, and an actuator unit 32 with a rotational-translational movement converter which has a piston 5, disposed so as to be movable in the axial direction relative to the caliper housing 2, and a spindle 6. The rotational-translational movement converter is designed as a ball screw (“KGT”) and further comprises a threaded nut 7 and balls 11 for force transmission.

The electromechanical brake device 100, according to the exemplary embodiment depicted, furthermore comprises an anti-rotation ring 3, a ring gear 4 which has an integrated rotary stop and sits on the spindle 6, a washer bearing 17, a bushing 20 which sits in the washer bearing 17, an axial bearing 18, in the exemplary embodiment shown designed as a double-row cylindrical roller bearing with cylindrical rollers 19, an axial washer bearing 16, a deformation member 9, in the exemplary embodiment shown with a sensor PCB 10, and a transmission element 13. Furthermore, provided is a sealing ring 30 which is disposed between the transmission element 13 and an intermediate cover 27, through which the transmission element 13 leads toward the outside.

The electromechanical brake device 100, according to the exemplary embodiments shown, furthermore comprises the force transmission unit 33 which transmits a drive torque, which can be provided by a drive unit 25, to the spindle 6.

The actuator unit 32 and the force transmission unit 33 are accommodated in the actuator receptacle 34 of the caliper housing 2, which also facilitates a compact construction mode.

The force transmission unit 33 comprises a ring gear 4, a planet carrier 21, a sun gear 35, which can be driven by the drive unit 25 via a gear wheel 24, and planet gears 12.

The spindle 6 is fixedly, for example co-rotationally, connected to the ring gear 4 so that a drive torque can be transmitted from the ring gear 4 to the spindle 6. For this purpose, the planet carrier 21 is fixed in the caliper housing 2. A piston-proximal portion of the planet carrier 21 protrudes into the cavity 37 of the spindle 6. In this way, an axial stop can be provided.

The drive unit 25 with the gear wheel 24 is accommodated in the exemplary embodiment in a separate housing 45, which is fixedly assembled on to the caliper housing. In this way, different drive units 25 and caliper housings 2 can be combined with one another to provide electromechanical brake devices 100 of different designs.

In the exemplary embodiment shown in FIG. 1, the spindle 6 comprises a cavity 37 which is formed as a cylindrical through-bore. In this way, a force sensor can be accommodated within the cavity 37 of the spindle 6, which enables a very compact construction mode in the axial direction.

Furthermore, provided is a circlip 23 which is disposed between the planet carrier 21 and the spindle 6. Conjointly with a locking ring 52 on the piston 5, these serve to be able to actively pull the piston 5 in the direction of release with the aid of the threaded nut 7. In FIGS. 1 and 2, this is a direction toward the right in the direction of the drive side.

The axial clamping force of the brake device 100 is supported by the following force flux: from the friction pad 31 via the piston 5, the threaded nut 7, the balls 11, the spindle 6, the washer bearing 17, the axial bearing 18, the axial washer bearing 16, the deformation member 9, the planet carrier 21, the planet carrier disk 40 into the caliper housing 2. The axial bearing 18 herein is disposed so as to be co-aligned between the washer bearing 17 and the axial washer bearing 16.

In an arrangement of the electromechanical brake device 100 the centrical installation position of the deformation member 9, which in the exemplary embodiment comprises a force sensor, or is designed as a force sensor, and thus has centrical introduction of force into the force sensor. This enables a precise detection of the brake application force.

In the exemplary embodiments of FIGS. 1 and 2, the deformation member 9 is embodied as a force sensor in a “button cell” construction, which makes it possible to measure an axial brake application force acting in the axial direction on the piston-proximal side of said force sensor.

Accordingly, an axial force can be transmitted from the axial washer bearing 16 to the deformation member 9 or the force sensor. According to an embodiment, for this purpose the drive-proximal end face of the axial washer bearing 16 is embodied to be spherically convex at least in the region close to the center. The entire drive-proximal end face of the axial washer bearing 16 can also be embodied to be spherically convex. As a result, an acting axial force can be introduced centrically into the deformation member 9, or the force sensor, respectively. Furthermore, potential tilting can also be compensated, for example in the case of a possible enlargement of the caliper housing 2 during a brake application procedure.

If the ball screw with the washer bearing and/or the axial washer bearing and the axial bearing 18 should tilt, the end face of spherical design can compensate for this tilt, and an acting force can still be introduced centrically into the deformation member 9, or the force sensor, respectively. The deformation member 9 is supported proximal to the drive on the planet carrier 21. For this purpose, the latter in the exemplary embodiment shown comprises an outer encircling collar.

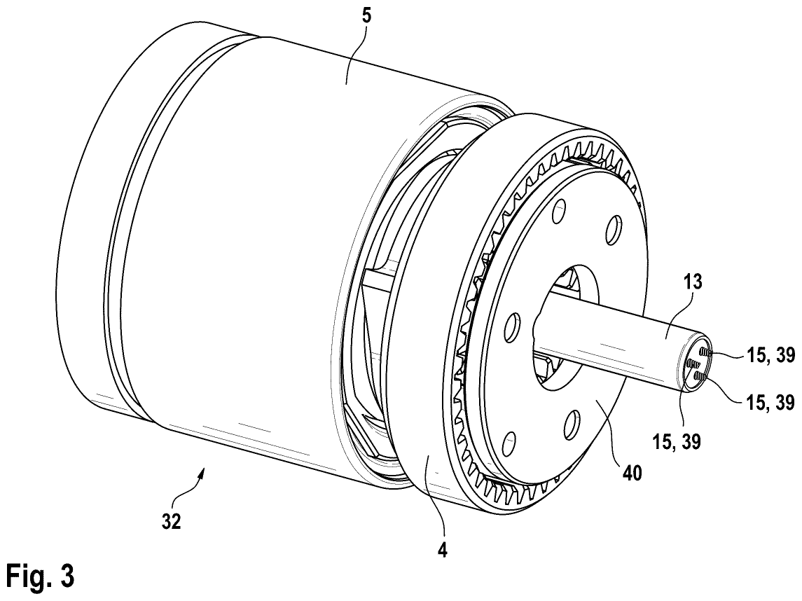

FIG. 3 shows an illustration of the actuator unit 32 in an oblique view.

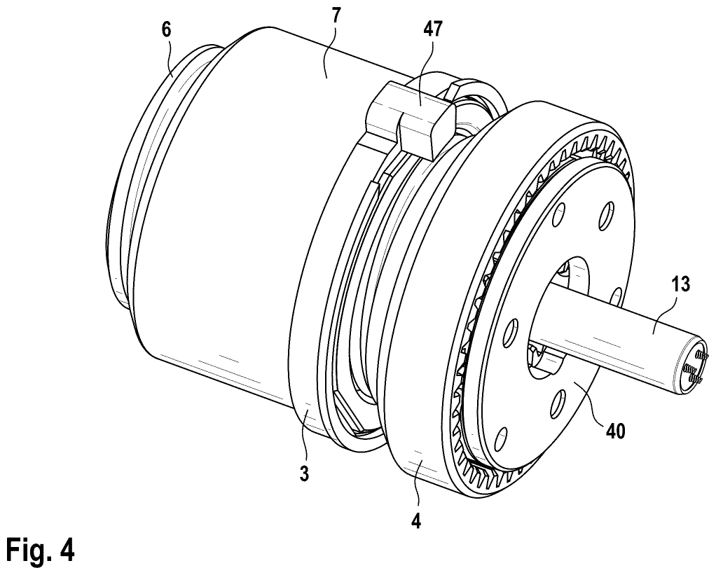

FIG. 4 shows a further illustration of the actuator unit 32 in an oblique view, wherein the piston 5 is not included in the illustration solely for the sake of clarity.

When the deformation member 9 is designed as a force sensor, stresses—for instance tensile or compressive stresses that are proportional to the axial force—can arise on the drive-proximal end face due to a deformation of the deformation member 9 by a piston-proximal axial force. These stresses can be detected, for example, with the aid of strain gauges on the drive-proximal end face of the force sensor. For measuring value acquisition, evaluation and/or preparation of the force measuring signals, as shown in the illustrated exemplary embodiment, a sensor PCB 10 with corresponding electronics components can be provided adjacent to the drive-proximal end face of the force sensor. For safety reasons, the force measuring signal can be detected redundantly. In this way, the detected force measuring signal can be processed and routed from the measuring point to the outside and emitted via a digital electrical data transfer interface.

According to an embodiment, it is provided that these signals are transmitted with the aid of contact springs from correspondingly formed contact faces 43 of the sensor PCB 10 to a control unit or a central electronic unit of the brake device 100, for example, a WCU (“Wheel Control Unit”), for which purpose an elongate transmission element 13 is provided in this exemplary embodiment. In this exemplary embodiment, the central electronic unit comprises a control unit 29, illustrated as a drive PCB. As can be seen in FIGS. 1 and 2, the control unit 29 is disposed outside the caliper housing 2 and can thus represent a part of the drive unit 25.

The elongate, cylindrical or substantially cylindrical transmission element 13 has at least one continuous electrical conductor 39 which thus enables a signal and data transmission through the transmission element 13. The electrical conductor 39 can be designed as a spring element or comprise spring elements. A suitable arrangement of the transmission element 13 can be readily seen in FIGS. 3 and 4. From the sensor PCB 10 in the cavity 37 of the spindle 6, the prepared measured values can thus be transmitted to a control unit 29 disposed outside the spindle 6. The transmission element 13 herein is disposed parallel to the longitudinal axis of the actuator unit 32.

In the exemplary embodiment, the transmission element 13 comprises a spring guide component 46 which may be made of plastics material.

The electrical conductors 39 extend through the spring guide component 46. For contacting the printed circuit boards, corresponding contact springs 15 are provided to transmit the signals from the sensor PCB 10 to the central control unit 29. In the exemplary embodiments, three electrical conductors 39 with correspondingly assigned contact springs 15 are provided solely for illustrative purposes. The contact springs 15 each establish the electrical contact for signal or data transmission on suitable contact faces 43 on the printed circuit boards.

According to an embodiment, the spring guide component comprises, or is surrounded, by a sleeve 42 which fixes this assembly to the force sensor. For this purpose, this sleeve 42 is pressed on the outside of the force sensor and is thus fixed to the latter, and moreover reliably seals the inner region with the sensor PCB 10 and the contact springs 15 against contamination by lubricating greases or other substances from the environment.

On the right-hand side in FIG. 1, a sealing ring 30 is provided at the feedthrough of the transmission element 13 through an intermediate cover 27, so that a protection against contamination by lubricating greases or other substances is likewise provided here. In this way, no substances from the gear compartment in which the gearwheels of the drive unit run and which may be provided with lubricant can enter the electronics compartment with the control unit 29.

The drive torque is transmitted as follows: emanating from an electric motor (not shown) via a gear assembly with spur gears (not shown), via the gear wheel 24 to the sun gear 35, from there to the planet gears 12, then to the ring gear 4 which is fixedly, for example co-rotationally, connected to the spindle 6. In the exemplary embodiment, there is a form-fitting connection. In this way, the spindle 6 can be rotationally driven, whereby said spindle is axially mounted so as to be rotational on the axial bearing.

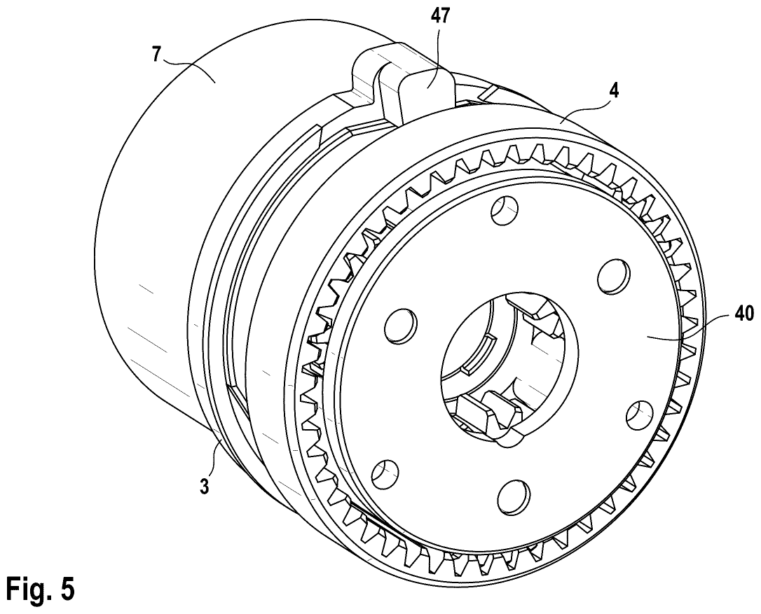

FIG. 5 again shows a further illustration of the actuator unit 32 in an oblique view, wherein the piston 5 and the transmission element 13 are not included in the illustration for the sake of clarity.

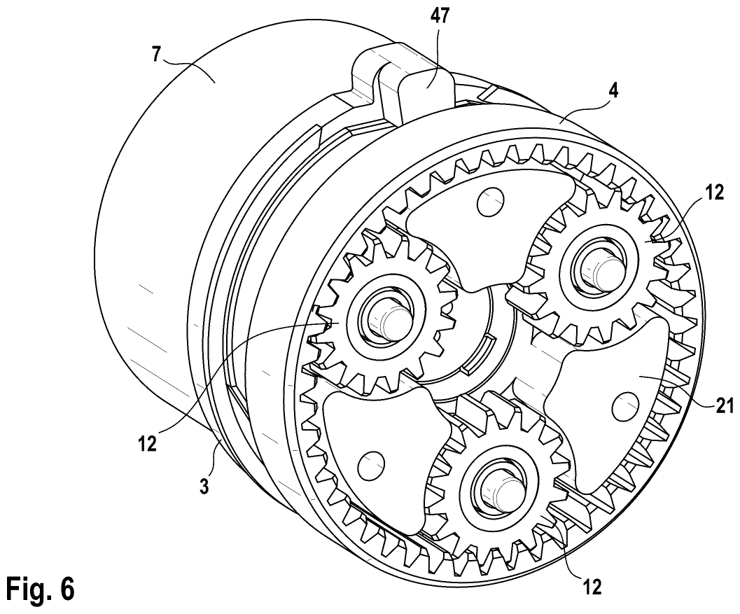

FIG. 6 shows a further representation of the actuator unit 32 from FIG. 5 in an oblique view, wherein the transmission element 13 and the planet carrier disk 40 are not shown for the sake of clarity.

In the electromechanical brake device 100, the planet carrier is fixed relative to the caliper housing 2. For this purpose, it can be fixedly connected to the caliper housing 2 using known connecting means, for example with screws, e.g. with three screws as shown in the exemplary embodiment, or alternatively also with bolts.

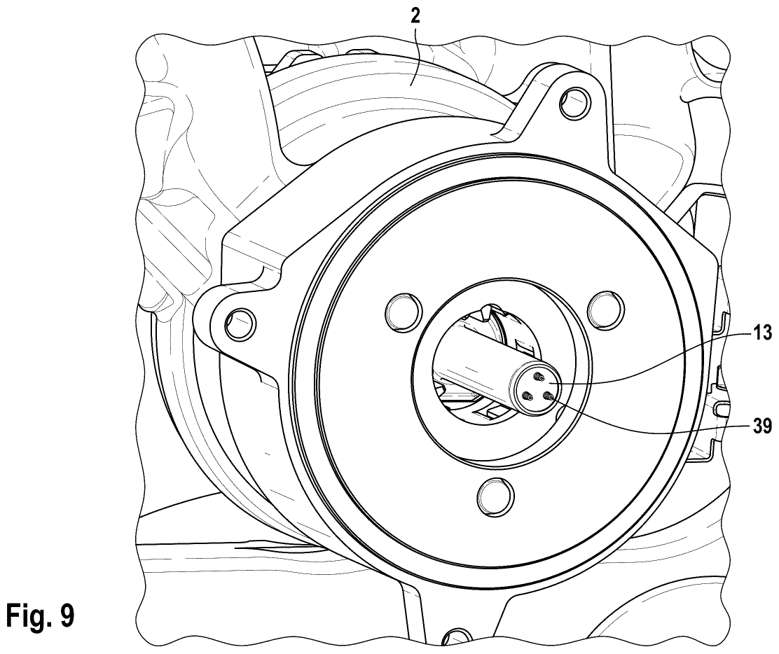

For this purpose, a further top view of a caliper housing is shown in FIG. 9. In the illustrated exemplary embodiment, the fastening to the caliper housing 2 is performed using three fastening bolts, whereby alternatively screws can also be used, for example. As a result, the planet carrier 21 is fixed in the caliper housing 2. In the sectional view of FIG. 1 or 2, one of the three screws or bolts that fix the planet carrier 21 and the planet carrier disk 40 in the caliper housing 2 can also be seen for illustrative purposes.

In the subassembly of the actuator unit 32 shown in FIG. 5, the planet carrier disk 40 can be readily seen in the foreground. The latter, conjointly with the planet carrier 21, forms the receptacle for the axles of the planet gears 12 and the planet gears 12 per se. The planet gears are, for example, mounted on the planet gear axles with needle sleeves, as can be seen in FIG. 1. Purely by way of example, three such planet gears 12 of this type are shown in each of the planetary gearboxes shown in the exemplary embodiments shown here. In the exemplary embodiment, the sun gear 35 is mounted in a radial bearing 8, in the example a tapered roller bearing, which sits in the gear housing and is presently fixed axially by a locking ring.

The sun gear 35 per se is fixed in the gear wheel 24 with the aid of a locking ring, as can be seen in FIG. 1. The sun gear 35 can be assembled in the gearbox from the left, for example, by inserting the former through the radial bearing 8, whereupon the gear wheel 24 can be inserted from the right and subsequently be fixed with a locking ring.

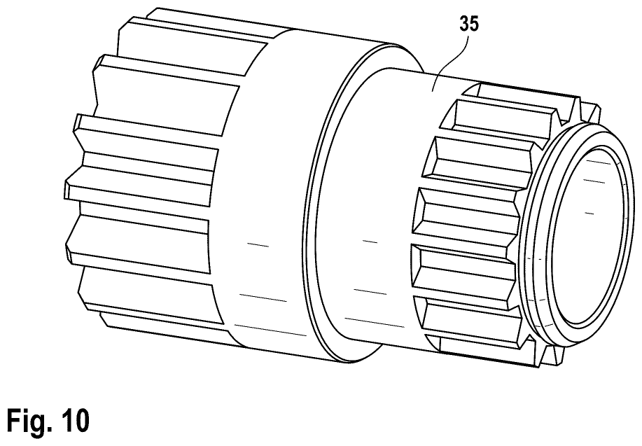

The sun gear 35 is illustrated in FIG. 10. On the right-hand side, said sun gear 35 has a toothing by way of which the drive torque from the gear wheel 24 can be transmitted in a form-fitting manner. On the left-hand side, the toothing for meshing in the planet gears 12 is shown.

In the embodiment shown in FIG. 6, the three webs, via which the axial force can be transmitted through the planet carrier 21 to the planet carrier disk 40 and then into the caliper housing 2, can be seen. A bore is provided within each of the webs, said bores being used for fixing the planet carrier 21 to the caliper housing 2, and through which bores correspondingly designed screws or bolts can be guided, for instance. However, screws may used, as they enable a reliable axial fixing of the planet carrier 21.

FIG. 7 shows an oblique view of the threaded nut 7 and the spindle 6. Illustrated in FIG. 7 is the toothing on the spindle 6 to which the ring gear 4 is axially attached, the torque thus being able to be transmitted in a form-fitting manner. The toothing also forms a press fit, so that the ring gear 4 is also fixed axially on the spindle 6.

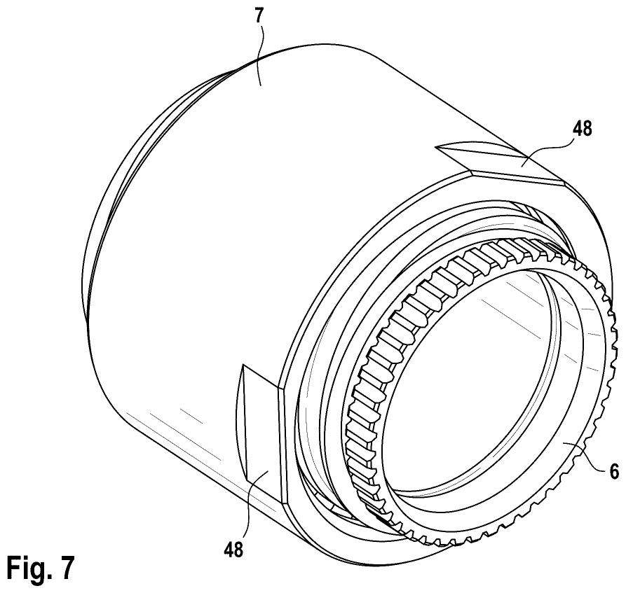

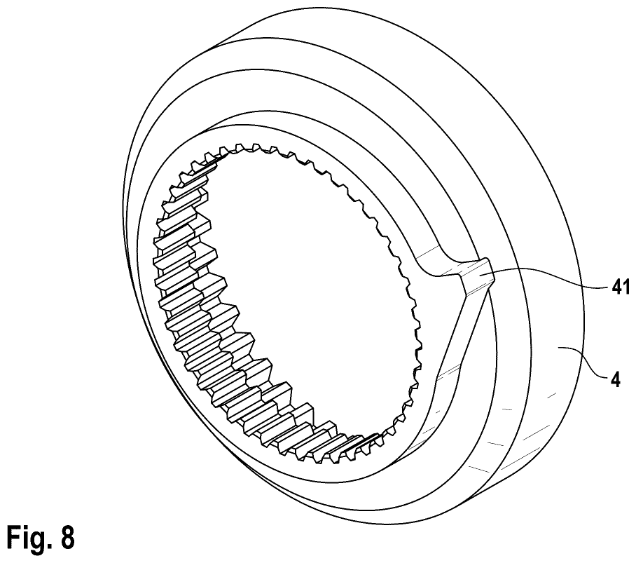

FIG. 8 shows an oblique view of the ring gear 4 with the toothing which is attached to the spindle 6. Moreover, it can be readily seen by means of the illustration that the ring gear is formed with a lobe 41 which is formed by a radially projecting cam on the ring gear 4. At a predetermined orientation, this lobe 41 can strike a pin 47 of the anti-rotation ring 3.

The anti-rotation ring 3 and the pin 47 can be readily seen in the illustrations of FIG. 4 or 5, for instance. The anti-rotation ring 3 sits on the threaded nut 7 and is connected to the latter in a co-rotational or form-fitting manner by means of three flats 48 on the external diameter of the threaded nut 7. These flats 48 can be readily seen in the illustration in FIG. 7. As a result, the threaded nut 7 is secured with the aid of the anti-rotation ring 3 in relation to twisting relative to the caliper housing 2, because the pin 47 runs in a groove in the caliper housing 2. In this way, it is guaranteed that the threaded nut 7 performs an axial movement when the spindle 6 is rotationally driven.

This is possible in both directions of movement of the ball screw. In the brake application direction, the threaded nut 7 travels conjointly with the piston 5 and the brake pad 31 in the direction of the brake disk (not shown), in FIG. 1 thus toward the left, and generates the desired brake application force. In the opposite detaching direction, the threaded nut 7 travels conjointly with the piston 5, the latter herein being entrained by the locking ring 52, in the release direction, in FIG. 1 accordingly toward the right.

Illustrated in FIGS. 3, 4 and 5 is the anti-rotation device, comprising the anti-rotation ring 3 with the pin 47, assembled on the threaded nut 7. The pin 47, which can also be embodied as a separate component, such as a bolt, has two functions:
the pin 47 forms the anti-rotation device of the threaded nut 7 in the caliper housing 2. For this purpose, a corresponding axially extending groove is provided in the actuator receptacle 34 of the caliper housing 2, in which groove the pin 47 is guided axially in an axial movement.
the pin 47 forms a rotary stop which the ring gear 4 by way of its lobe 41 strikes tangentially in a predetermined orientation. This rotary stop forms the rear stop of the actuator unit 32.

The anti-rotation ring 3 in the exemplary embodiment is assembled on three flats on the threaded nut 7, i.e. three faces formed on the threaded nut 7. The anti-rotation ring 3 can likewise be assembled axially, by attaching it to the threaded nut 7. In FIG. 7, two of the three flats 48 formed for this purpose on the threaded nut 7 can be seen.

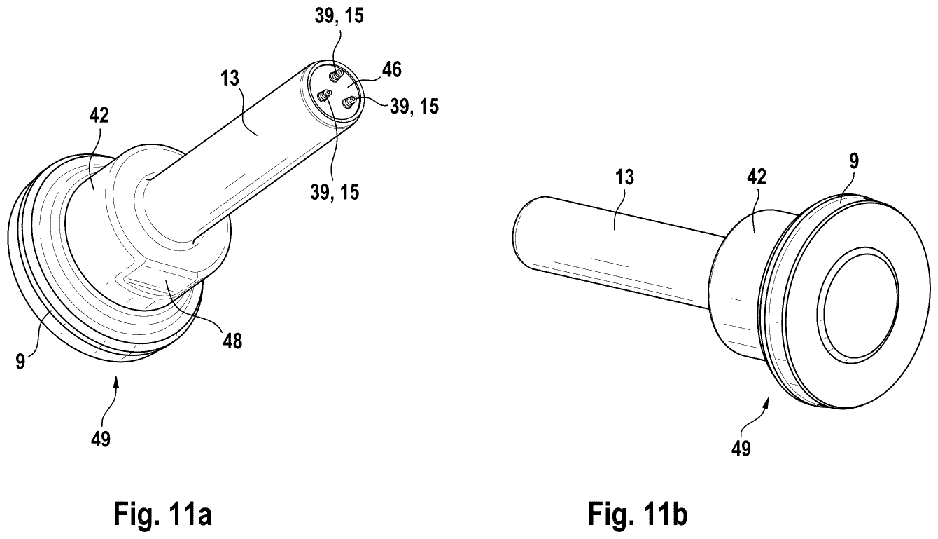

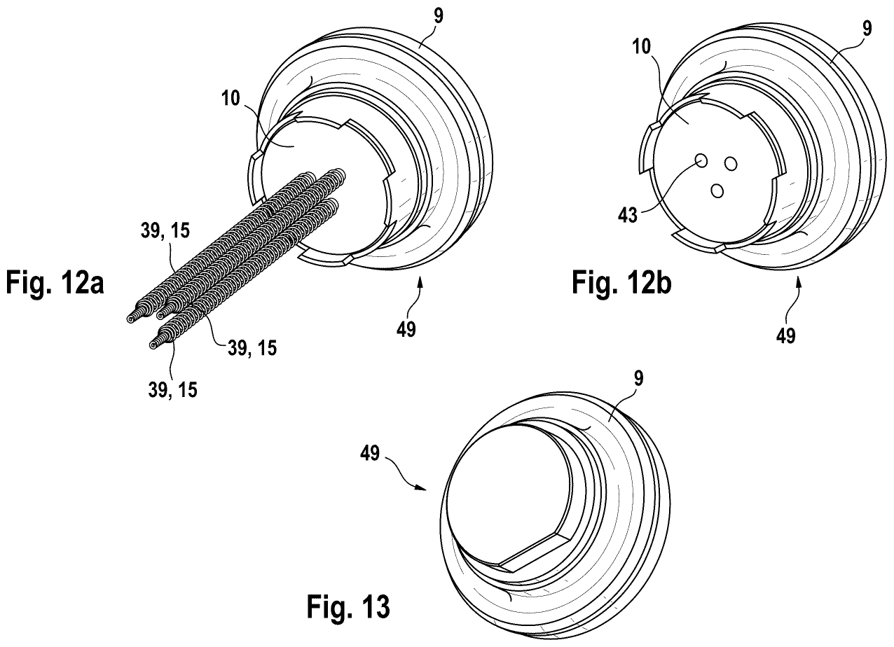

FIGS. 11a and 11b show oblique views of the force sensor 49 with transmission element 13. FIGS. 12a, 12b and 13 show further oblique views of parts of the force sensor 49 and of the transmission element 13.

In the exemplary embodiments shown, the deformation member 9 is embodied as a force sensor 49. Accordingly, the deformation member 9, under the influence of an axial force acting on its piston-proximal end face, is designed to cause stresses on its drive-proximal end face, which stresses can be detected by means of suitable sensors, or sensor elements, for example strain gauges.

In principle, however, it is also possible, for instance if no force sensor is desired, to use only a correspondingly designed member as a deformation member 9.

In order to assemble the force sensor 49 in a defined installation position, it has a suitable shape to ensure an unequivocally oriented installation during assembling. For this purpose, a sleeve 42 with a bevel 48 is provided in the exemplary embodiment. The planet carrier 21 has a correspondingly matching contour with an exact fit. In other embodiments, it is also possible to provide, for instance, pins, cams, or other geometrical configurations in order to ensure a defined unequivocal installation position.

Since the planet carrier 21 is also assembled so as to be oriented in the caliper housing 2, an unequivocal installation position of the force sensor 49 is thus achieved overall. This is very important to ensure that the three electrical contact springs 15 of the force sensor are correctly positioned.

In the illustration shown in FIG. 12a, the spring guide component 46 and the sleeve 42 are removed so that the conductors 39 are visible. The latter are embodied as contact springs 15. Embodiments in which the electrical conductor 39 is embodied as a rigid conductor, and corresponding spring elements for contacting are disposed only in the contact region, are also possible. In FIG. 12b, these conductors 39 are also removed so that the sensor PCB 10 is clearly visible. On the latter, the contact faces 43 are plotted, which ensure contacting of the electrical conductors 39 of the transmission element.

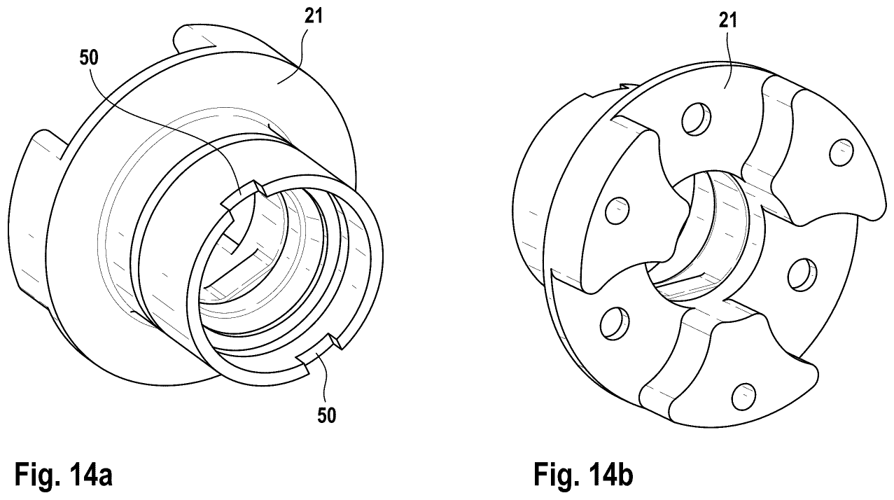

FIGS. 14a and 14b show two oblique views of the planet carrier 21, wherein in FIG. 14a a piston-proximal view and in FIG. 14b a drive-proximal view are shown.

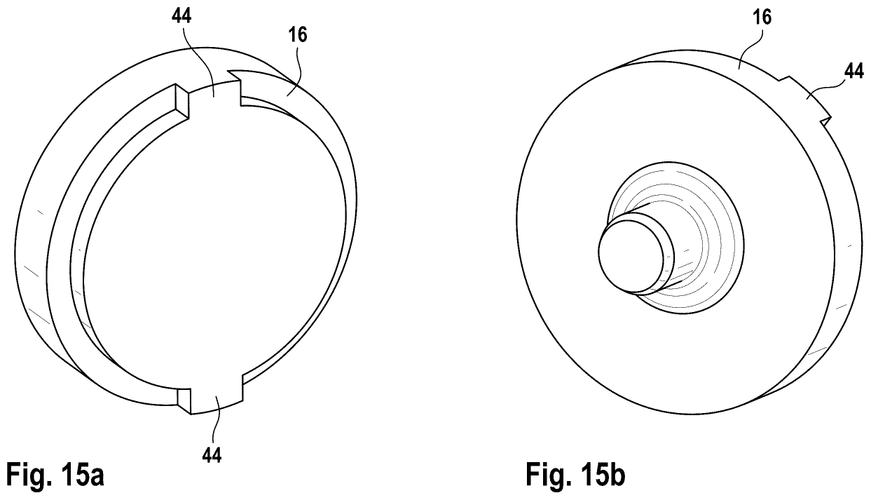

In the view shown in FIG. 14a, two recesses 50 on the end face can be seen, which are disposed so as to correspond to two anti-rotation devices 44 of the axial washer bearing 16. These anti-rotation devices 44 of the axial washer bearing 16 can be easily derived from FIGS. 15a and 15b.

Of course, a different number of recesses 50 or anti-rotation devices 44 is also possible, which moreover applies, for example, to the number of planet gears 12 or conductors 39 mentioned in the exemplary embodiments.

An electromechanical brake device 100, for example for a motor vehicle without a force sensor, can also be provided. For this purpose, the spindle 6 according to a second embodiment, may only be embodied in a drive-proximal portion with a cavity 37. This embodiment can be applied when no sensor is required. In this way, the spindle 6 can be manufactured more cost-effectively and/or can also be embodied to be more stable. The attachment to the force transmission unit 33 through the drive-proximal cavity 37 can be carried out analogously to the embodiment with a continuous cavity 37.

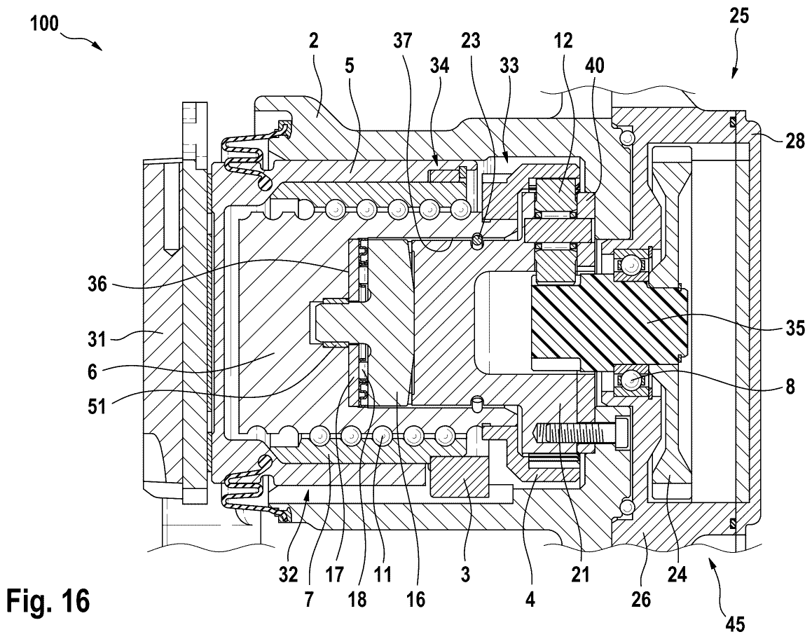

For this purpose, FIG. 16 shows an illustration of a second exemplary electromechanical brake device 100, in the longitudinal section.

The axial bearing 18 and the associated washer bearing 17 as well as the axial washer bearing 16 are placed within the cavity 37 of the spindle 6, which spindle is embodied to be hollow in portions for this purpose. This means that the installation size of the entire assembly can be as short as possible.

The electromechanical brake device 100 according to the embodiment from FIG. 16 comprises the caliper housing 2, the piston 5, the threaded nut 7, the spindle 6, the balls 11, an anti-rotation ring 3, the ring gear 4 with integrated rotary stop, the washer bearing 17, a bushing 51 which sits in the spindle 6, the axial bearing 18, in the example embodied with cylindrical rollers, the axial washer bearing 16, planet gears 12, circlip 23 between the planet carrier 21 and spindle 6, planet carrier disk 40, locking ring 52 in the piston 5, sun gear 35, bearing 8 for the sun gear 35, a large gear wheel 24, gear housing 26 and a gear cover 28.

The axial clamping force of the electromechanical brake device 100 is supported by the following force flux, from the brake pad 31 via the piston 5, the threaded nut 7, the balls 11, the spindle 6, the washer bearing 17, the axial bearing 18, the axial washer bearing 16, the planet carrier 21, a planet carrier disk 40, into the caliper housing 2.

The spherically designed drive-proximal end face of the axial washer bearing 16 allows the actuator unit 32 to tilt conjointly with the axial bearing 18 and the washer bearings 17. If the actuator unit 32 should tilt due to an enlargement of the caliper housing 2 when the wheel brake is applied, the spherical face helps most to minimize the uneven distribution of force on the axial bearing 18 and the tilting moment on the actuator unit 32.

The drive torque is transmitted as follows: emanating from an electric motor (not shown) via the spur gears (not shown) and/or via the gear wheel 24 to the sun gear 35, to the planet gears 12, to the ring gear 4 which is co-rotationally connected to the spindle 6. The connection between the ring gear 4 and the spindle 6 can designed in a form-fitting and/or force-fitting manner. In this way, the spindle 6 can be rotationally driven and is mounted axially so as to be rotatable on the axial bearing 18.

FIG. 17 shows an illustration of the actuator unit from FIG. 16 in an oblique view, FIG. 18 shows a further illustration of the actuator unit from FIG. 16 in an oblique view, wherein the piston 5 is not included in the illustration.

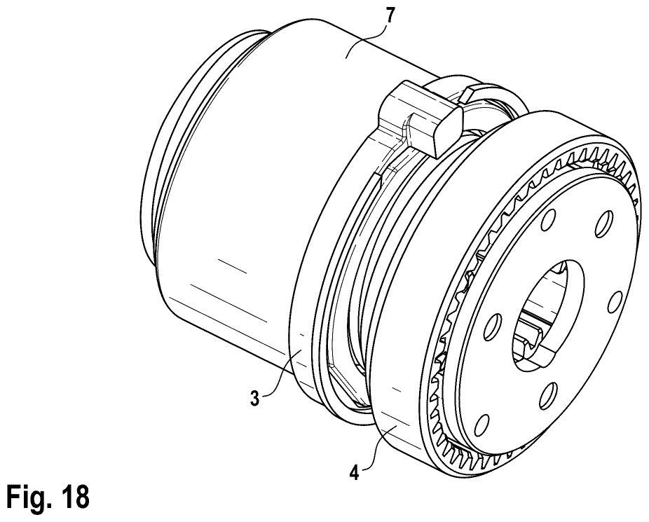

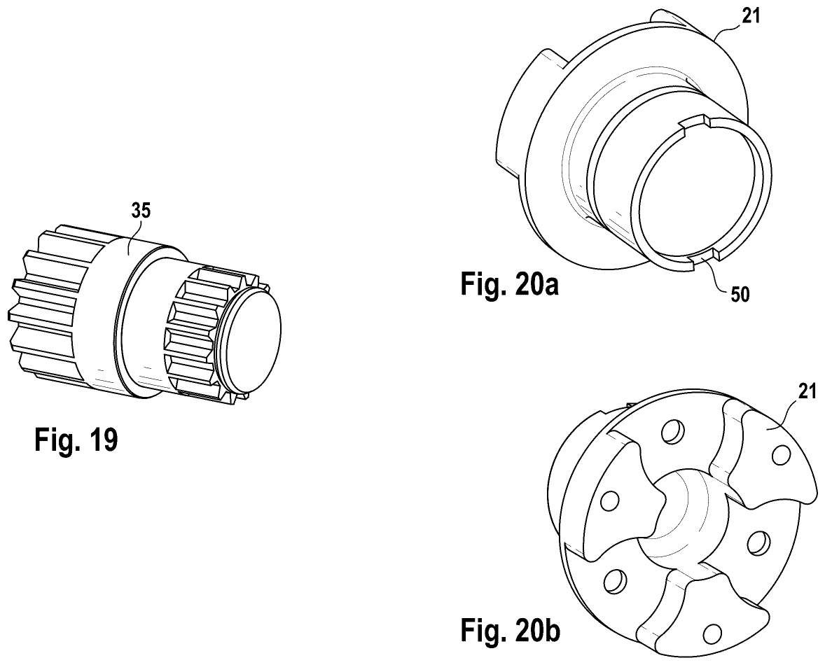

FIG. 19 shows an oblique view of a sun gear 35 which can be used for the actuator unit from FIG. 16, and FIGS. 20a, 20b show oblique views of a suitable planet carrier.

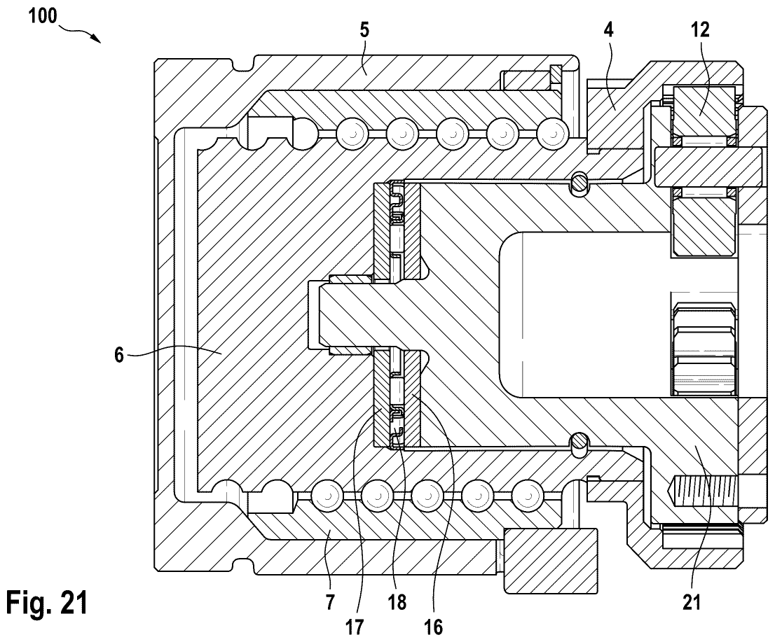

FIG. 21 shows a further representation of a third exemplary electromechanical brake device 100 in longitudinal section. Only a few components relevant for clarification are shown in the illustration depicted; others, e.g. the sun gear, are not included in the drawing for the sake of clarity.

In this exemplary embodiment, the axial washer bearing 16 is designed to be planar, or substantially planar, on both sides instead of spherical. The washer bearing 17 and the axial washer bearing 16 can thus be of identical design, which simplifies production. In this embodiment with two planar axial washer bearings 16, 17, the actuator unit 32 and the axial bearing 18 can barely tilt. This embodiment is therefore suitable for applications in which the actuator unit 32 and the axial bearing 18 must not be designed to be tiltable, or if the actuator unit 32 and the axial bearing 18 are to be designed so that they can absorb the uneven force distribution resulting from the non-tiltable design.

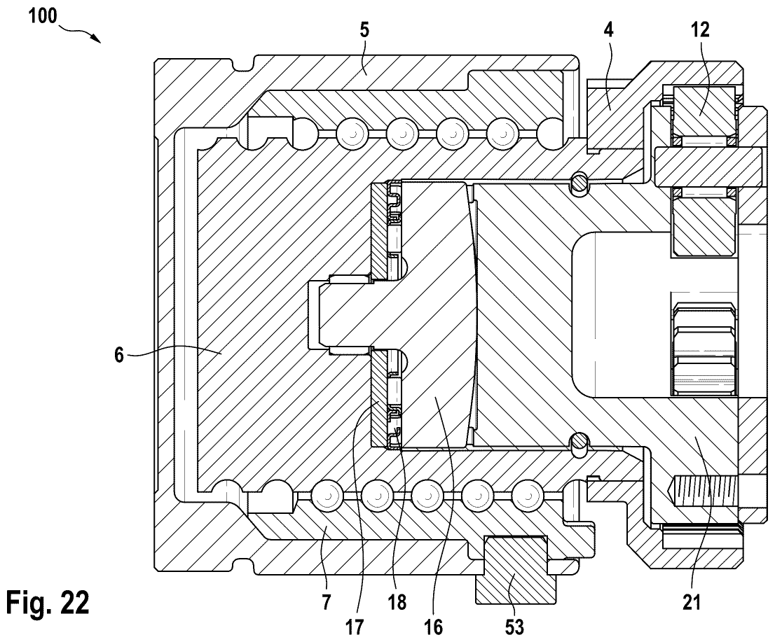

FIG. 22 shows a further illustration of a fourth exemplary electromechanical brake device 100, in the longitudinal section. In the illustration depicted, likewise only a few components relevant for clarification are shown; others, e.g. the sun gear, are not included in the drawing for the sake of clarity.

In this embodiment, the anti-rotation device comprises a locking element 53 which can be disposed, for example, between the threaded nut 7 and the housing and/or the piston 5. In the example of FIG. 22, the locking element 53 is designed purely by way of example as a pin or nail.

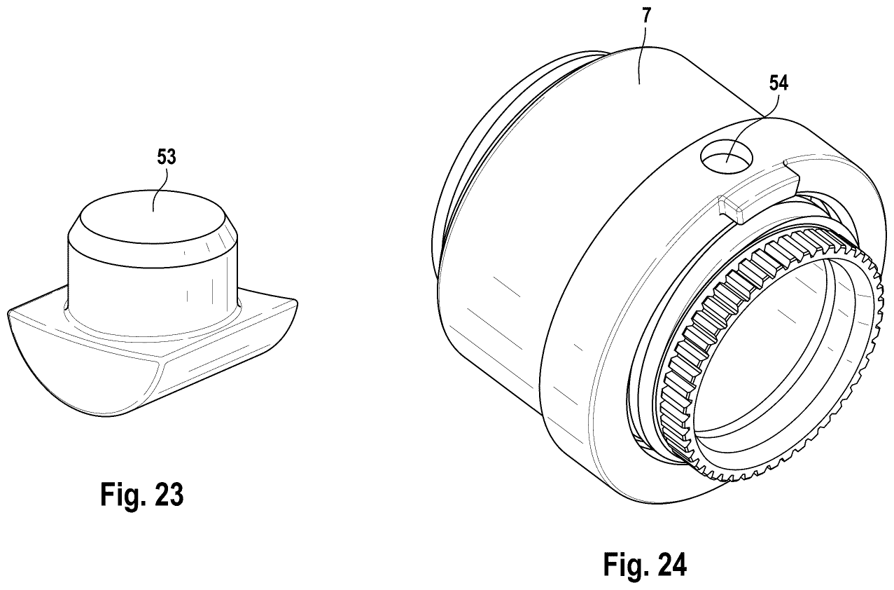

For this purpose, FIG. 23 shows an illustration of the locking element 53, and FIG. 24 shows an illustration of a spindle with a threaded nut.

The locking element 53 can be inserted into an opening 54 in the threaded nut 7, as can be seen, for instance, in FIG. 24. As a result, the threaded nut 7 can be secured axially within the piston 5. For this purpose, the locking element 53 can comprise, for example, a circular portion which is inserted into a correspondingly matching opening 54 with an exact fit, which is embodied as a bore. The opposite portion of the locking element 53 can be guided, for example, in a groove in the caliper housing 2. As a result, the threaded nut 7 can be secured in relation to twisting relative to the caliper housing 2.

Due to the construction of the proposed electromechanical brake device 100, a compact installation size can be achieved, for example a low axial extent. If the electromechanical brake device 100 is to be used in narrow installation spaces of vehicle, for example on front axles, in which this axial length measure may be of consequence due to the steering movement.

The invention claimed is:

1. An electromechanical brake device for a motor vehicle comprising:
an actuator unit wherein the actuator unit comprises a rotational-translational movement converter having a piston movable in an axial direction and a spindle wherein the spindle is hollow at least in portions, to at least partially define a cavity;
a force transmission unit, wherein the force transmission unit comprises a planetary gearbox with a sun gear, planet gears, a planet carrier and a ring gear; and
an axial bearing located in the cavity for absorbing axial forces occurring during brake application.

2. The electromechanical brake device as claimed in claim 1, further comprising a caliper housing, wherein the rotational-translational movement converter is designed as a ball screw, wherein a threaded nut is provided for the transmission of force, and wherein the piston is movable relative to the caliper housing.

3. The electromechanical brake device as claimed in claim 2, wherein the piston is co-rotationally connected to the threaded nut.

4. The electromechanical brake device as claimed in claim 2, wherein at least one of the spindle is fixedly connected to the ring gear and the planet carrier is fixedly connected to the caliper housing.

5. The electromechanical brake device as claimed in claim 2, wherein the planet carrier protrudes at least in portions into the cavity.

6. The electromechanical brake device as claimed in claim 1, wherein the cavity is designed to be a continuous cylindrical through-bore.

7. The electromechanical brake device as claimed in claim 1, further comprising a washer bearing provided in the cavity which proximal to the piston is mounted in the axial direction by a stop of the spindle and proximal to the drive is in contact with the axial bearing.

8. The electromechanical brake device as claimed in claim 7, further comprising an axial washer bearing provided in the cavity which proximal to the piston is in contact with the axial bearing.

9. The electromechanical brake device as claimed in claim 8, wherein the axial bearing is aligned between the washer bearing and the axial washer bearing.

10. The electromechanical brake device as claimed in claim 7, wherein at least one of the washer bearing and the axial washer bearing is planar on both sides.

11. The electromechanical brake device as claimed in claim 7, wherein an end face of the axial washer bearing proximal to the drive is spherically convex at least in a region close to a center of the axial washer bearing.

12. The electromechanical brake device as claimed in claim 11, further comprising a deformation member in the cavity of the spindle which proximal to the piston is in contact with the axial washer bearing, with the spherical region of the end face of the axial washer bearing.

13. The electromechanical brake device as claimed in claim 12, wherein the deformation member is supported in the axial direction proximal to the drive on the planet carrier.

14. The electromechanical brake device as claimed in claim 12, wherein the deformation member is a force sensor and comprises at least one sensor element.

15. The electromechanical brake device as claimed in claim 12, wherein the deformation member proximal to the drive has at least one electrical contact face.

16. The electromechanical brake device as claimed in claim 15, further comprising an elongate transmission element having at least one continuous electrical conductor, which proximal to the piston is connected in an electrically conducting manner to the electrical contact face, and which proximal to the drive is connected in an electrically conducting manner to a control unit and wherein the transmission element leads through the force transmission unit.

17. The electromechanical brake device as claimed in claim 1, wherein the ring gear comprises a radially projecting lobe in the region of a piston-proximal end face.

18. A motor vehicle, which comprises at least one electromechanical brake device comprising:
an actuator unit wherein the actuator unit comprises a rotational-translational movement converter having a piston movable in an axial direction and a spindle wherein the spindle is hollow at least in portions, to at least partially define a cavity;
a force transmission unit, wherein the force transmission unit comprises a planetary gearbox with a sun gear, planet gears, a planet carrier and a ring gear; and
an axial bearing located in the cavity for absorbing axial forces occurring during brake application.
